(19) United States
(12) Patent Application Publication
(10) Pub. No.: US 2005/0076078 A1
(43) Pub. Date: Apr. 7, 2005

(54) Event based communication system

(76) Inventor: Ruby Salton, Maccabim (IL)

Correspondence Address: WILMER CUTLER PICKERING HALE AND DORR LLP, 399 PARK AVENUE, NEW YORK, NY, 10022, US

(21) Appl. No.: 10/621,558

(22) Filed: Jul. 17, 2003

Related U.S. Application Data
(60) Provisional application No. 60/397,857, filed on Jul. 23, 2002.

(51) Int. Cl. G06F 15/16

(52) U.S. Cl. 709/201

(57) ABSTRACT

A system and method for facilitating contact between people attending common events. The system comprises a members' database, including at least pictures of the members and contact information. A member attending an event notifies the system of his location and may subsequently browse through the pictures of the other participants to locate another person he wishes to contact.

### CROSS-REFERENCE TO RELATED APPLICATIONS

The present application claims the benefit of the filing date of co-pending U.S. provisional application, Ser. No. 60/397,857 filed Jul. 23, 2002, entitled “Event and Location Based Contact System”.

### FIELD OF THE INVENTION

The present invention provides a computerized client-server system, intended to facilitate contact between people participating in common events.

### BACKGROUND OF THE INVENTION

In modern life, especially in the Western world, where people tend to get married at a relatively older age, on the one hand, and divorce is very common, on the other hand, the population of single men and women has grown to very large dimensions.

Single people who wish to meet others may do so while going about their daily routine, such as at their working place, school, or any recreation facility, or attend special location and/or events, such as singles bars/parties.

With the advent of the Internet, new opportunities for matchmaking arose, and indeed numerous websites dedicated to matching singles exist and flourish. These systems all work on a similar basis; a person wishing to join the service as a subscriber must fill-in his/her own personal data and data relating to the desired partner. The system holds these in a database and may perform periodical or on-demand scans of the database to come up with the best fit.

WO02/01405 to Hancock, discloses a system that allows users to locate people with the common interests, or to find people who would satisfy a current need (e.g. a job vacancy). The system can make use of existing telecommunication and networking services as well as the Internet, WAP, GPS, and other protocols to provide location information. Alternatively, various locations may have card readers installed at which users update their “location” field in the database by swiping their card through the reader. Micromaps can also be provided to further pinpoint the user's location. Each user of the system provides a personal profile of their business, social or private interests. The users may login to the system via an Internet access device or a mobile phone and search the database for compatible matches. Any matche may be sent a text message in which the sender's anonymity is preserved. The user may also subscribe to various services that deliver information depending on the user's location. Such services may deliver information regarding movies, taxis, performances, traffic conditions, etc.

All these existing systems use databases, whether static or dynamic, to match people according to predefined information, such as hobbies, interests, education, religion, and so forth.

There is need for a new “matching” mechanism, to help people “meet” someone they already know by sight, or by name, or by any one of other identification parameters.

### SUMMARY OF THE INVENTION

The present invention provides means for facilitating contact between people attending common events, before, during or after the event has taken place.

In one aspect of the present invention there is provided an event-based communication system comprising:
A computer-based server, said server running a server application of said communication system;
A plurality of electronic devices communicating with said server; and
A database residing on said server, said database comprising at least pictures of subscribers to said communication system, information regarding events, and cross-correlation between said events and participants in said events from among said subscribers,

Wherein said electronic devices communicate with said server application regarding a specific event, for updating and retrieving said database information of said specific event, or for updating and retrieving therefrom information regarding one or more participants in said specific event, said information regarding participants comprising at least pictures or video-clips.

At least one said events may be virtual.

The electronic devices may comprise wireless devices.

The electronic devices may comprise at least one computer running a client application of the communication system.

The information regarding subscribers may comprise personal identification data and contact data.

The client application may comprise sending commands to the server.

The commands may prompt the server to manipulate said database.

The client application may comprise sending queries to the server and receiving replies from the server.

The electronic devices may comprise at least one Contact Center, communicating with the server, said Contact Center comprising at least input means for entering identification data into the server.

The input means may comprise a barcode reader and/or a magnetic-card reader, or any other suitable identification mechanism.

The Contact Center may additionally comprise a computer-based system running a Contact Center application.

The Contact Center may additionally comprise a digital camera and/or a printer.

The input means may additionally comprise input means for entering queries into the Contact Center application, and the Contact Center application may comprises means for sending the queries to the server and receiving responses to said queries from the server.

The responses may comprise textual responses, pictures or video-clips.

In another aspect of the present invention, there is provided a method of enabling communication with a person attending a specific event, the method comprising the steps of:

Providing an event-based communication system comprising a computer-based server, said server running a server software application of said communication system, said server additionally comprising a database residing on said server, said database comprising at least information regarding subscribers to said communication system, information regarding events, and cross-correlation between said events and participants in said events from among said subscribers,

Said server communicating with at least one electronic device, wherein said communication with said at least one electronic device comprises communication regarding said specific event, for updating said database information of said specific event, or for retrieving therefrom information regarding one or more participants in said specific event, said information regarding participants comprising at least pictures or video-clips; and

Receiving present location information of at least one said subscribers.

Receiving present location information may comprise receiving automatic location information from a GPS, wireless or Bluetooth device.

Receiving present location information may comprise receiving an MMS message or an SMS message indicating said location.

At least one said events may be virtual.

The electronic devices may comprise wireless devices.

The electronic devices may comprise at least one computer running a client software application of said communication system.

The information regarding subscribers may comprise personal identification data and contact data.

Communication with said at least one electronic device may comprise receiving commands from said electronic device.

Communication with said at least one electronic device may comprise receiving queries from said electronic device and sending replies to said electronic device.

The replies may comprise at least one of text, picture and video-clip.

Communication with said at least one electronic device may additionally comprise receiving a further communication from said electronic device, following said step of sending a reply.

The received further communication may be forwarded to said person attending said specific event.

The further communication may comprise an MMS message.

The electronic devices may comprise at least one Contact Center, communicating with said server, said Contact Center comprising:

A computer-based system running Contact Center software application; and input means for entering identification data into said Contact Center software application.

The input means may comprise at least one of a barcode reader and a magnetic-card reader, or any other suitable identification mechanism

Receiving present location information may comprise using said input means for reading said present location information.

The Contact Center may additionally comprise a digital camera and/or a printer.

The input means may additionally comprise input means for entering queries into said Contact Center application, and wherein said Contact Center application comprises using said Contact Center for sending said queries to said server and receiving responses to said queries from said server.

The responses may comprise textual responses, pictures and video-clips.

In a further aspect of the present invention, there is provided a method of contacting a person attending an event, the method comprising the steps of:
Providing an event-based communication system comprising a computer-based server, said server running a server software application of said communication system, said server additionally comprising a database residing on said server, said database comprising at least information regarding subscribers to said communication system, said information about subscribers comprising at least pictures or video-clips, information regarding events, and cross-correlation between said events and participants in said events from among said subscribers;
Providing a Contact Center in the location of said event and at the time of said event, said Contact Center comprising at least a computer with Internet access, a Contact Center software application and input means for entering identification data into said Contact Center software application; and
Using said input means of said Contact Center application for communicating with said server.

The input means may comprise a barcode reader and/or a magnetic-card reader.

The Contact Center may comprise a digital camera and/or a printer.

Using said input means may comprise entering commands into said Contact Center application.

Using said input means may comprise entering a query into said Contact Center application and receiving a response to said query from said Contact Center application.

A command may be sent to said Contact Center application, following said receiving a response.

Said person attending said event may be contacted, following said receiving a response.

The query may comprise requesting a list of said subscribers attending said event and wherein said response comprises said list of said subscribers attending said event.

The query may comprise requesting the pictures of said subscribers attending said event and wherein said response comprises said pictures of said subscribers attending said event.

In yet another aspect of the present invention there is provided a Contact Center for communicating between people attending an event and a location-based contact server, said server comprising a database, said Contact Center comprising:
A computer-based system with Internet access; and
A Contact Center software application running on said computer, said software application enabling said people attending said event to send queries to said server and receive responses from said server, said queries and responses relating to other people attending said event.

The software application may additionally enable said people attending said event to send commands to said server.

The commands may prompt said server to manipulate said database.

The Contact Center may additionally comprise a digital camera controlled by said computer.

The software application may additionally enable said people attending said event to use said digital camera for taking their own picture and wherein said pictures are communicated by said Contact Center to said database.

The Contact Center may additionally comprise a printer controlled by said computer.

In another aspect of the present invention there is provided a method of identifying a person previously located in at least one of a series of locations, the method comprising the steps of:
Providing an event-based communication system comprising a computer-based server, said server running a server software application of said communication system, said server additionally comprising a database residing on said server, said database comprising at least information regarding subscribers to said communication system, said information about subscribers comprising at least pictures or video-clips, information regarding events, and cross-correlation between said events and participants in said events from among said subscribers;
Providing at least one electronic location device in communication with said server;
Using said at least one electronic location device to transmit a starting present location to said server;
Further using said at least one location device to transmit a subsequent series of locations to said server;
Sending a query to said server regarding people present in at least one of said series of locations at the time said location was transmitted; and
Receiving a reply from said server, said reply comprising at least one picture of at least one person.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic illustration of the system according to the present invention;

FIG. 2 is a schematic description of the Contact Center according to an embodiment of the present invention;

FIG. 3 is a schematic description of the database according to an embodiment of the present invention;

FIG. 4 is a block diagram of one exemplary mode of operation of present invention; and

FIG. 5 is a block diagram of a second exemplary mode of operation of present invention.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Event, in the context of the present invention, refers to a combination of time and location. For example, sitting on a beach on a Saturday morning is an event; people in a fitness club on a certain day are participating in an event; people in a cafe in a certain time frame are participating in an event; two people glancing at each other in the traffic light may also be considered as sharing an event, etc. An event may also be a party, a wedding, a sports event, a cruise, a week in a resort club, etc. An event can alternatively be a virtual event—people chatting in a chat room on the Internet, or people watching the same TV show or channel.

The actual contact between participants in an event, with the aid of the system of the present invention, may take place before, during, or after the event.

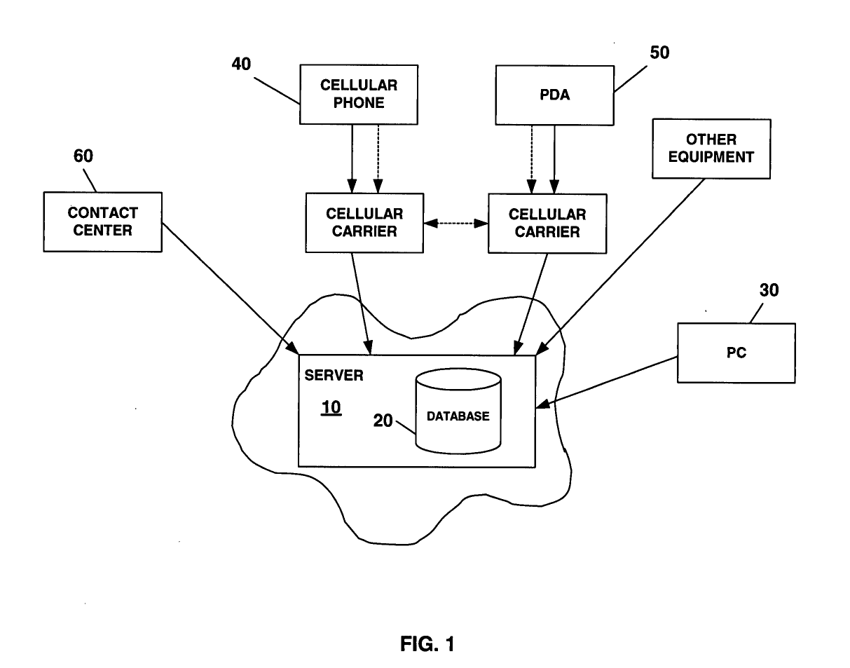

FIG. 1 is a schematic illustration of the system's architecture. The core of the system is an Internet server 10, or server farm, or distributed network, comprising one or more databases 20. The server runs a server application. Various client applications, such as Internet browser running on a PC 30, cellular phone 40 or PDA 50 may be connected to the server 10 through a cellular carrier or through any other 3^{rd} party service company. An additional device that may be connected to the server is a “Contact Center” 60.

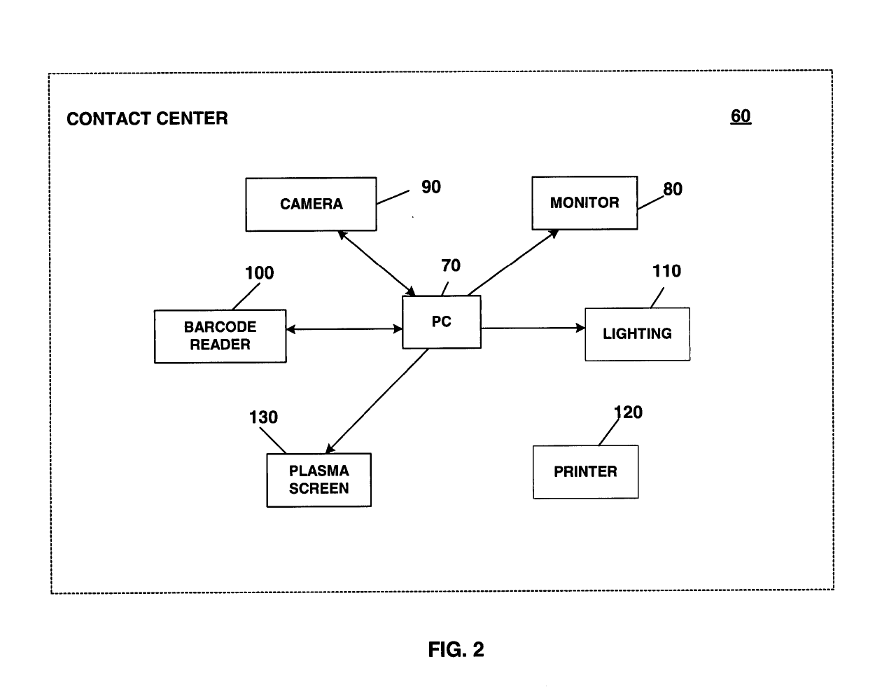

The Contact Center 60, as shown in detail in FIG. 2, to which attention is now drawn, is a specially designed system that may be installed in any public or private location, comprising a computer 70 with Internet connection, with any combination of touch screen or regular monitor 80, a digital video camera (regular or web cam) 90, a barcode reader or magnetic card reader 100, or any suitable identification mechanism, lighting mechanism 110, a color printer and/or a thermal printer 120. The printer may be any kind of printer, such as a label printer, a photo printer etc. Optionally, several touch screens may be connected to the Contact Center. An additional option is to connect an external screen 130, e.g. a big plasma screen. The minimum configuration of a Contact Center may comprise only a suitable identification mechanism such as magnetic-card reader connected to the server through a modem or other networking device. In an offline mode, the Contact Center may operate without Internet connection. The operation of the Contact Center 60 will be described in detail hereinbelow.

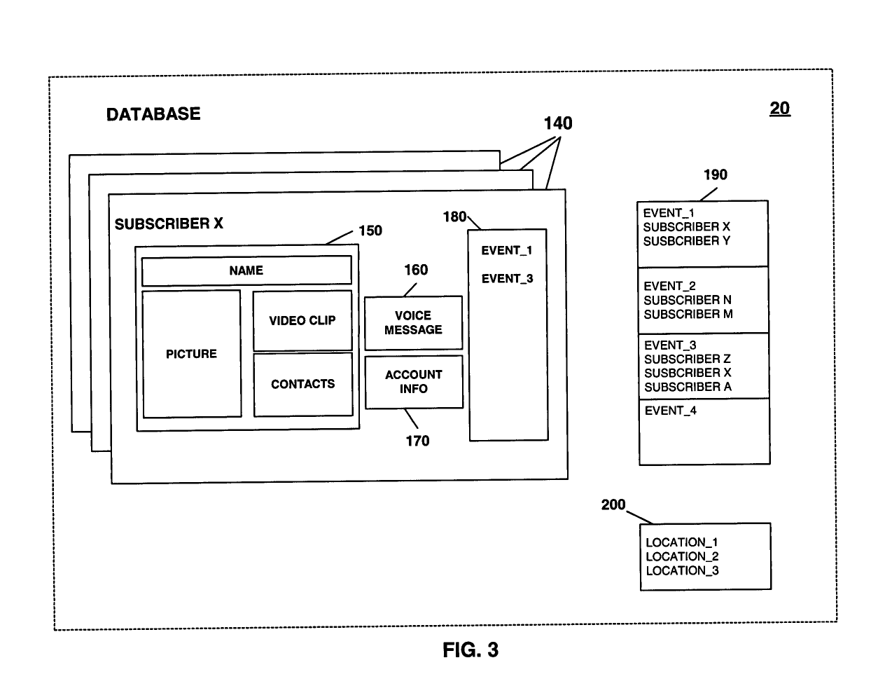

FIG. 3 is a schematic description of the database 20 residing on the server 10 according to an embodiment of the present invention. The database 20 comprises subscribers' records and files 140, each containing personal information 150 provided by the subscriber, such as subscriber's name, subscriber's picture, video clip showing subscriber, and contact information, such as e-mail address and/or cellular phone number. The subscriber's file 140 may additionally comprise storage space 160 for incoming voice messages and account information 170. The subscriber's file 140 additionally comprises, or is related to an event-table 180, listing recent, present and future events attended by subscriber and storing subscriber's pictures and video clips from the event.

The database 20 additionally comprises a central events table 190, and a locations table 200, both common to all subscribers. Central events table 190 holds information about all the events registered in the system, including a definition of the event, as a combination of location and time, general pictures, video clips and other media related to the event. The media may include general or personalized sponsors' advertisements.

Central events table 190 additionally comprises, for each event, a list of attending subscribers. An event may be a past, present or future event. A cross-correlation exists between the events listed in, say, subscriber X's event-table 180 and the entry holding the participants list in each event.

Locations are defined in central locations table 200.

Server Application

The server may be implemented, for example, as an XML/HTTP web service, with an API (Application Interface) that allows third party companies, vendors, web site owners, developers, etc. to manipulate the database using their own proprietary user interface. For example, if a convention producer wishes to use the service in a convention he produces he may implement his own user interface, using the published API of the system, and get the full range of services. Charging may be done by number of API calls, number of events operating the system, etc.

The server application comprises queries and updates to the database, such as:
Register user
Upload picture
Insert event
Delete contact
Send Message
Mutual Request: A special service that will notify members of a contact match only if both parties have asked for it.
Fake user report—when user A has a suspicion about the honesty of user B he may report that suspicion to the server; the server tracks these reports and signals for users that are:
   a. Suspected of being fake (many users have reported about them).
   b. Suspected of reporting about fake users with no real reason.

Both types of users will be suspended from the service and their cellular phone number (or other unique identification) “black-listed” against future attempts to rejoin the service.

Client Application

The client application, running on any client device such as PC, PDA or Cell phone, comprises queries and updates to the server's database, such as:
Register
Show all events (in a city/area)
Select event
Show all event members
Show member's picture
Compose message
Send password—in case user has forgotten it
Increase user credit

The client applications get the data from the server in XML format and may use XSL transformations, for example, to display the data in the correct layout, according to the specific client device properties, such as screen size and shape.

In SMS mode, the user may send any of the available queries as SMS commands. The cellular carrier transfers the command either directly or via third-party service company (mediator) to the system. The system receives the content of the message and the originating phone number, handles the query and may send back a response.

All system-originated messages may be sent by e-mail, SMS or MMS, not requiring that the receiver be on-line when message is sent.

Mode of Operation

The system of the present invention provides the user with the ability to contact other users who are concurrently at the same place (either physical or virtual, as mentioned above), or who have attended the same event regardless of the exact time, or who intend to attend the same event.

The particular method of the present invention addresses, for example, the case where a person attends an event, such as a party, a sports event, a convention, an exhibition, etc., or is at a certain location such as a pub, a restaurant, a swimming pool, etc. or in a certain virtual location such as web site or cable TV channel. The person may “see” (in the physical or virtual sense) another person on such an occasion, with whom he desires to make contact and for various reasons does not have the opportunity to do so. Alternatively, a person may have prior information regarding someone he would like to meet and who is supposed to be at the same event, but has no idea what the other person looks like; he may only know the other person's name, or phone number, or the company he works for, or his member ID in the service of the present invention, etc.

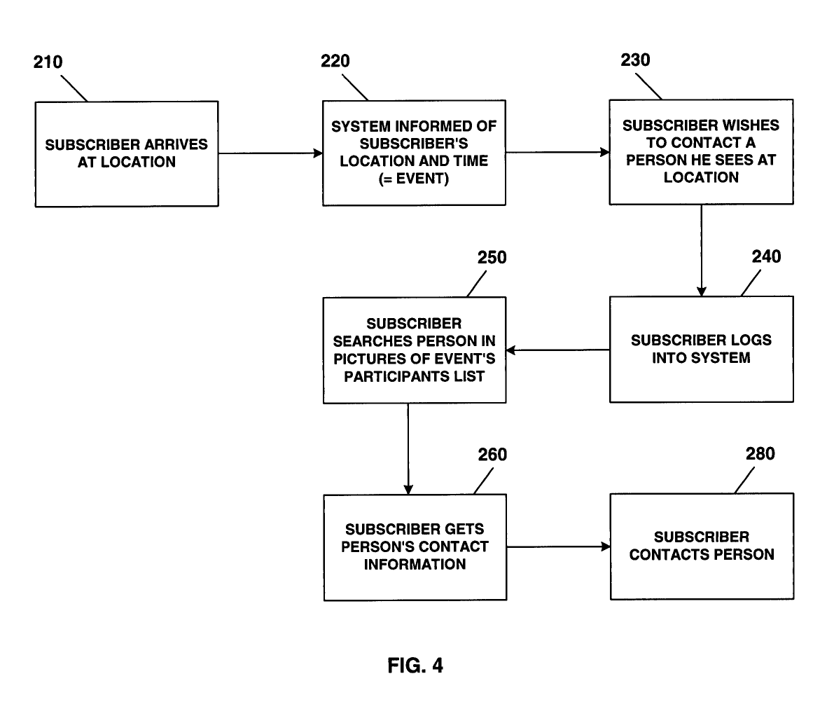

The method of the present invention provides solutions to the above-mentioned cases. FIG. 4 is a block diagram of one exemplary mode of operation of the present invention. In step 210, subscriber arrives at a certain location. In step 220, system is informed about subscriber's location. This may be done in one of several ways; the subscriber may use his/her cellular phone or PDA to log-in to the system via Internet connection, or any Cellular/Wireless connection and web technology such as Bluetooth, Infrared, GPS, GPRS, WAP, J2ME, 3^{rd} generation, WiFi etc. Alternatively, a unique electronic device may be placed in predefined locations to communicate with cellular phones or other personal devices people carry, such as Bluetooth, WiFi or infrared hubs. This unique device collects signals from such carried electronic devices and notifies the system by SMS, or Internet connection, or any other mechanism, that user X is in a Location Y on time Z. WiFi technology, for example, is highly compatible with such a workflow. In a further embodiment, the present location of a member may be identified automatically by any available technological means such as GPS, WiFi or Bluetooth and will be sent automatically to the system.

Large convening locations, such as convention centers, exhibition halls, big pubs or clubs, shopping malls, hotels, cruise lines, club resorts, wedding halls and gardens, may install an especially designed Contact Center in their premises, as described above in conjunction with FIG. 2. Alternatively, a Contact Center may be installed in e.g. a private house, for a specific event. In yet another embodiment, the Control Center's application may be installed on any PC or laptop computer, thus turning it into a functioning Control Center terminal. The system of the present invention may also be operated on train rides, airplane flights etc., serving as events, with or without a Control Center positioned in main terminals such as train stations and airports. People attending the event may get, upon entrance, a special card with a unique barcode printed on it, or a magnetic card, or identification by the cellular device, or by typing login and password, or by infra-red beam, Bluetooth, or smart card, or digital ID card etc. At the Contact Center, the reader reads the user identification information into the system and may prompt the user to assume a certain position for his picture or video to be taken. Pictures and/or video clips of registered or yet unregistered members, taken by the Contact Center during an event, will be automatically uploaded to the relevant event on the server. Additionally, general pictures taken by digital or video cameras during an event may be uploaded to the system by connecting the capture devices to a special port in the Contact Center's terminal, or by transmitting the digital images to the Contact Center via infrared connection, or Bluetooth connection, or any other suitable communication mode. The pictures will be transferred to the server and connected automatically to the relevant event in the database. The pictures or video clips may be displayed on the Contact Center's monitor or on a large screen at the location or out side the location. The member may ask the system to send a specific media file e.g. certain photo or video clip in MMS or e-mail to another member, e.g. a friend or a family member. The pictures/video clips may also be sent to the system from the member's home computer. Member may request to download some or all of the event's pictures, taken by him and/or others. All the pictures/video clips sent or displayed by the system may contain general or personalized sponsors' advertisement.

When the member has returned home, or to any other location where he has computer connection, or wireless Internet connection e.g. cellular, he may login to the system with his card ID, identification by phone number+login+password or any other unique identification in the system, and fill-in missing information required by the system.

Referring back to FIG. 4, in step 230 the subscriber sees another person and wishes to establish contact. If the subscriber has not logged-in to the system yet, he may now do so (step 240), using any one of the methods described above. Once a member has logged-in to the service, he/she may browse through a list of pre-registered events or locations. Alternatively, the member may dial-in the location and time, or other description of the event, as it is taking place. In yet another alternative, the member may send an SMS command to the servers, notifying his current location, or use any known in the art wireless communication method such as Bluetooth or GPS. If the database does not hold a picture or video clip of the member, or if the member wishes to update his/her picture or video, he may now do so by using the digital camera or digital video camera of his cellular phone, such as FOMA D2101V and FOMA P2101V, available from NTT DoCoMo, Japan, or Samsung 932 or Nokia 7650.

Having logged into the system, the member may now query the system for other participants in the same event (step 250), particularly the person who has aroused his/her interest, by browsing through the pictures or videos of the subscribers registered under the current event. Once the person of interest has been located in the database, he may be contacted through the server. Contact may now be made, in steps 260, 280, in any of the available manners, such as, but not limited to:
Send message via the server
Send eMail via the server
Send SMS via the server
Send MMS (Multimedia message which includes voice and/or video and/or photo data) via the server
Establish voice conversation via the server
Establish video conversation via the server
Establish chat conversation via the server
   Alternatively, if the person of interest who has been located in the database, had chosen to publish personal contact information—a direct connection between the users may now take place in any of the available manners, such as, but not limited to:
Send direct eMail
Send direct SMS
Send direct MMS (Multimedia message which includes voice and/or video and/or photo data)
Establish direct voice conversation
Establish direct video conversation

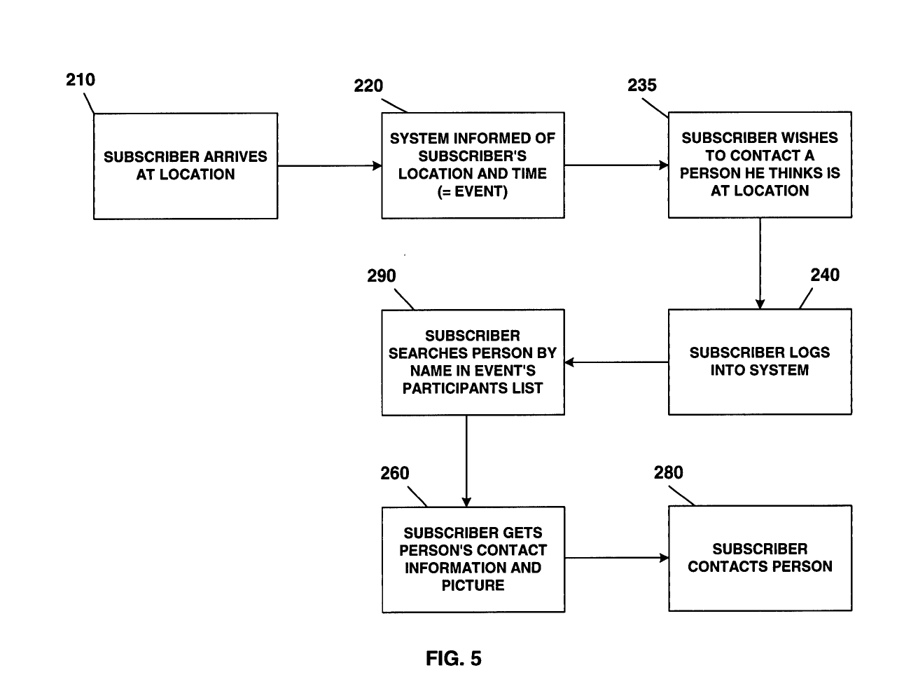

In another exemplary embodiment, as schematically described in the FIG. 5, the member may query the system about a specific name of a person, a member ID number, or any other known identification detail, to find out whether that person is attending the same event, or to locate a person he/she knows only by the known identification detail (step 235). Having logged-in to the system in a similar manner as described above in conjunction with FIG. 4, the subscriber may now browse the current event's participants' list (step 290) to search for his desired contact person by the known identification detail. If the person matching the known identification detail is found, contact may be established in any one of the manners as described above in conjunction with FIG. 4.

Member may also ask for some or all of the pictures of members attending the event (and of general pictures that were taken during the event) to be printed, whether on the printer 120 at the Contact Center, or on their home printer, depending on the member's whereabouts. Members may alternatively ask the system to receive the pictures and/or clips by email or MMS.

Members may also browse through all the pictures or videos of other members participating in the same event and get contact information.

A member may mark some of his/her favorite users and subsequently get notification when some of these favorite persons attend the same event.

Service members who do not participate in a certain event may also get the possibility to browse through the event's pictures and contact participants, preferably in accordance with the participants' account settings.

In an additional operation mode of the system, each member attending an event may print a special tag on the Contact Center's printer, using his member ID. The member may carry this tag on his shirt during the event. Others can now send him messages via the system, directly and immediately, according to this ID. This can be achieved by sending SMS with the ID number and text to the server, who will deliver the message to the recipient, or by wireless Internet in cellular phones, or by special messaging terminals distributed in the location.

The system of the present invention may also serve for organizing social games in an event. For example, two participating members are each shown a picture of the other (for example by MMS) and they have one minute to locate each other and send validation by SMS; or, a member is shown a picture of another member and has to guess the other person's age, name, etc. Other games, such as Bingo, or participation in a lottery, or any other contest or survey may also be conducted between users using SMS/MMS messages (e.g. choose the most beautiful girl, the funniest clip, etc.).

Another service provided by the system of the present invention enables automatic creation of a website for the event/party by uploading all the media gathered in the Control Center to the new website, including user clips, user photos, general clips, general photos, forums, chats etc.—all related to the event.

The system may be used for other applications—like collecting handwriting from users and sending a graphological analysis back by SMS, email etc. User may also get a list of candidates attending the same event, who seem to match user's preferences according to the graphological analysis. Alternatively, the system may use any other matching criterion to recommend and/or establish communication between members, including members' specific indication that they are interested in establishing contact.

Virtual events may also be created by the system. Users who wish to participate in a virtual event send SMS with the virtual event or location code and are now all participants in the same virtual event and can communicate accordingly.

The database of the system, as described above, may serve as a research and marketing tool; the database holds information about which events users prefer, ages, hot locations, etc., data of great value for event organizers or other companies (e.g. Coca Cola wants to advertise to 18 years old girls who frequent night clubs) for sending promotion, advertisements and coupons. Coupons may be sent to a member during an event, printed on the Control Center's printer and used on the spot, or at a later time. Alternatively, cellular coupons and advertisements may be sent to members using SMS or MMS. Alternatively, sponsors may use the system for sales promotion in various other manners, such as rewarding picture/video clips senders with a prize.

In an additional application of the system of the present invention, the definition of an event may be broadened to include any location a person visits at any given time, or during a certain time-span. For example, a member of the service may notify the system, by his cellular phone or any GPS device, or any other location device, that he is presently at a certain location, and send a special command indicating that he is entering a “follow me” mode. In the “follow me” mode the system is informed continuously, or at pre-determined intervals, of the member's whereabouts, until the members send an “end follow me” command. This mode of operation enables the member to “find”, at a later point in time, any other member who had crossed his path during the active “follow me” period and who has informed the system of his location during that period.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. Event-based communication system comprising:
a computer-based server, said server running a server application of said communication system;
a plurality of electronic devices communicating with said server; and
a database residing on said server, said database comprising at least pictures of subscribers to said communication system, information regarding events, and cross-correlation between said events and participants in said events from among said subscribers,
wherein said electronic devices communicate with said server application regarding a specific event, for updating and retrieving said database information of said specific event, or for updating and retrieving therefrom information regarding one or more participants in said specific event, said information regarding participants comprising at least pictures or video-clips.

2. The event-based communication system of claim 1, wherein at least one said events is virtual.

3. The event-based communication system of claim 1, wherein said electronic devices comprise wireless devices.

4. The event-based communication system of claim 1, wherein said electronic devices comprise at least one computer running a client application of said communication system.

5. The system of claim 1, wherein said information regarding subscribers comprises personal identification data and contact data.

6. The system of claim 4, wherein said client application comprises sending commands to said server.

7. The system of claim 6, wherein said commands prompt said server to manipulate said database.

8. The system of claim 4, wherein said client application comprises sending queries to said server and receiving replies from said server.

9. The system of claim 1, wherein said electronic devices comprise at least one Contact Center, communicating with said server, said Contact Center comprising at least input means for entering identification data into said server.

10. The system of claim 9, wherein said input means comprise one of a barcode reader and a magnetic-card reader.

11. The system of claim 9, wherein said Contact Center additionally comprises a computer-based system running a Contact Center application.

12. The system of claim 11, wherein said Contact Center additionally comprises at least one of a digital camera, and a printer.

13. The system of claim 11, wherein said input means additionally comprise input means for entering queries into said Contact Center application, and wherein said Contact Center application comprises means for sending said queries to said server and receiving responses to said queries from said server.

14. The system of claim 13, wherein said responses comprise at least one of textual responses, pictures and video-clips.

15. A method of enabling communication with a person attending an specific event, the method comprising the steps of:
providing an event-based communication system comprising a computer-based server, said server running a server software application of said communication system, said server additionally comprising a database residing on said server, said database comprising at least information regarding subscribers to said communication system, information regarding events, and cross-correlation between said events and participants in said events from among said subscribers,
said server communicating with at least one electronic device, wherein said communication with said at least one electronic device comprises communication regarding said specific event, for updating said database information of said specific event, or for retrieving therefrom information regarding one or more participants in said specific event, said information regarding participants comprising at least pictures or video-clips; and
receiving present location information of at least one said subscribers.

16. The method of claim 15, wherein said receiving present location information comprises receiving automatic location information from a GPS, wireless or Bluetooth device.

17. The method of claim 15, wherein said receiving present location information comprises receiving an MMS message or an SMS message indicating said location.

18. The method of claim 15, wherein at least one said events is virtual.

19. The method of claim 15, wherein said electronic devices comprise wireless devices.

20. The method of claim 15, wherein said electronic devices comprise at least one computer running a client software application of said communication system.

21. The method of claim 15, wherein said information regarding subscribers comprises personal identification data and contact data.

22. The method of claim 15, wherein said communication with said at least one electronic device comprises receiving commands from said electronic device.

23. The method of claim 15, wherein said communication with said at least one electronic device comprises receiving queries from said electronic device and sending replies to said electronic device.

24. The method of claim 23, wherein said replies comprise at least one of text, picture and video-clip.

25. The method of claim 23, wherein said communication with said at least one electronic device additionally comprises receiving a further communication from said electronic device, following said step of sending a reply.

26. The method of claim 25, additionally comprising the step of forwarding said received further communication to said person attending said specific event.

27. The method of either of claims 25 and 26, wherein said further communication comprises a MMS message.

28. The method of claim 15, wherein said electronic devices comprise at least one Contact Center communicating with said server, said Contact Center comprising at least input means for entering identification data into said server.

29. The method of claim 28, wherein said Contact Center additionally comprises a computer-based system running Contact Center software application.

30. The method of claim 28, wherein said input means comprise at least one of a barcode reader and a magnetic-card reader.

31. The method according to claim 28, wherein said receiving present location information comprises using said input means for reading said present location information.

32. The method of claim 29, wherein said Contact Center additionally comprises at least one of a digital camera and a printer.

33. The method of claim 30, wherein said input means additionally comprise input means for entering queries into said Contact Center application, and wherein said Contact Center application comprises using said Contact Center for sending said queries to said server and receiving responses to said queries from said server.

34. The method of claim 33, wherein said responses comprise at least one of textual responses, pictures and video-clips.

35. A method of contacting a person attending an event, the method comprising the steps of:
providing an event-based communication system comprising a computer-based server, said server running a server software application of said communication system, said server additionally comprising a database residing on said server, said database comprising at least information regarding subscribers to said communication system, said information about subscribers comprising at least pictures or video-clips, information regarding events, and cross-correlation between said events and participants in said events from among said subscribers;
providing a Contact Center in the location of said event and at the time of said event, said Contact Center comprising at least a computer with Internet access, a Contact Center software application and input means for entering identification data into said Contact Center software application; and
using said input means of said Contact Center application for communicating with said server.

36. The method of claim 35, wherein said input means comprise at least one of a barcode reader and a magnetic-card reader.

37. The method of claim 35, wherein said Contact Center comprises at least one of a digital camera and a printer.

38. The method of claim 35, wherein said using said input means comprises entering commands into said Contact Center application.

39. The method of claim 35, wherein said using said input means comprises entering a query into said Contact Center application and receiving a response to said query from said Contact Center application.

40. The method of claim 39, additionally comprising the step of sending a command to said Contact Center application, following said receiving a response.

41. The method of claim 39, additionally comprising the step of contacting said person attending said event, following said receiving a response.

42. The method of claim 39, wherein said query comprises requesting a list of said subscribers attending said event and wherein said response comprises said list of said subscribers attending said event.

43. The method of claim 39, wherein said query comprises requesting the pictures of said subscribers attending said event and wherein said response comprises said pictures of said subscribers attending said event.

44. A Contact Center for communicating between people attending an event and a location-based contact server, said server comprising a database, said Contact Center comprising:
a computer-based system with Internet access; and
a Contact Center software application running on said computer, said software application enabling said people attending said event to send queries to said server and receive responses from said server, said queries and responses relating to other people attending said event.

45. The Contact Center of claim 44, wherein said software application additionally enables said people attending said event to send commands to said server.

46. The Contact Center of claim 45, wherein said commands prompt said server to manipulate said database.

47. The Contact Center of claim 44, additionally comprising a digital camera controlled by said computer.

48. The Contact Center of claim 47, wherein said software application additionally enables said people attending said event to use said digital camera for taking their own picture and wherein said pictures are transferred by said Contact Center to said database.

49. The Contact Center of claim 44, additionally comprising a printer controlled by said computer.

50. A method of identifying a person previously located in at least one of a series of locations, the method comprising the steps of:
providing an event-based communication system comprising a computer-based server, said server running a server software application of said communication system, said server additionally comprising a database residing on said server, said database comprising at least information regarding subscribers to said communication system, said information about subscribers comprising at least pictures or video-clips, information regarding events, and cross-correlation between said events and participants in said events from among said subscribers;
providing at least one electronic location device in communication with said server;
using said at least one electronic location device to transmit a starting present location to said server; and
further using said at least one location device to transmit a subsequent series of locations to said server.

51. The method of claim 50, additionally comprising the steps of:
sending a query to said server regarding people present in at least one of said series of locations at the time said location was transmitted; and
receiving a reply from said server, said reply comprising at least one picture of at least one person.
